(19) United States
(12) Patent Application Publication
(10) Pub. No.: US 2024/0011656 A1
(43) Pub. Date: Jan. 11, 2024

(54) DETERMINATION SYSTEM

(71) Applicant: DAIKIN INDUSTRIES, LTD., Osaka (JP)

(72) Inventors: Koji NAGASAWA, Osaka (JP); Tadafumi NISHIMURA, Osaka (JP); Yuta IZUMI, Osaka (JP); Takeshi HASEGAWA, Osaka (JP)

(21) Appl. No.: 18/371,740

(22) Filed: Sep. 22, 2023

Related U.S. Application Data
(63) Continuation of application No. PCT/JP2022/014432, filed on Mar. 25, 2022.

(30) Foreign Application Priority Data
Mar. 26, 2021 (JP) 2021-053139

(51) Int. Cl. F24F 11/47

(52) U.S. Cl. CPC F24F 11/47; F24F 2140/60

(57) ABSTRACT

A determination system determines an appropriate air conditioning system. The determination system includes a control unit, storage unit, and input unit. The control unit generates a first system candidate for an air conditioning system to be determined. The control unit acquires first information relating to weighting of initial and running costs of the first system. The control unit acquires, based on the first information, a degree of how the total cost is affected by the initial and running costs. The control unit calculates total cost by adding the initial and running costs based on the degree. The storage unit stores the first system and the total cost calculated in association with each other. The first information is input into the input unit. The control unit determines, from the first system, the first system the total cost of which satisfies a first criterion as the appropriate air conditioning system.

### CROSS-REFERENCE TO RELATED APPLICATIONS

This is a continuation of International Application No. PCT/JP2022/14432 filed on Mar. 25, 2022, which claims priority to Japanese Patent Application No. 2021-053139, filed on Mar. 26, 2021. The entire disclosures of these applications are incorporated by reference herein.

### BACKGROUND

### Technical Field

The present disclosure relates to a determination system.

### Background Art

As described in Japanese Unexamined Patent Application Publication No. 2002-215760, there is known a system that determines an appropriate air-conditioning system on the basis of a total cost that is the sum of an initial cost and a running cost of an air-conditioning installation.

### SUMMARY

A determination system of a first aspect determines an appropriate air-conditioning system. The determination system includes a control unit, a storage unit, and an input unit. The control unit generates a first system that is a candidate for an air-conditioning system to be determined. The control unit acquires first information relating to weighting of an initial cost and a running cost of the first system in a total cost of the first system including the initial cost and the running cost. The control unit calculates the total cost on the basis of the initial cost, the running cost, and the first information. The storage unit stores the first system and the total cost calculated by the control unit in association with each other. The first information acquired by the control unit is input into the input unit. The control unit determines, from the first system stored in the storage unit, the first system the total cost of which satisfies a first criterion as the appropriate air-conditioning system.

### BRIEF DESCRIPTION OF THE DRAWINGS

FIG. 1 is a diagram showing an example of the configuration of an air-conditioning system 100 that is a target of determination by a determination system 10.

FIG. 2 is a diagram showing an image of an installation system 120 determined from among candidate systems 110 by the determination system 10.

FIG. 3 is a schematic block diagram of the determination system 10.

FIG. 4 is a flowchart showing processing in which the determination system 10 determines an installation system 120.

FIG. 5 is a diagram showing an example of a display for inputting weighting information (a first example).

FIG. 6 is a diagram showing an example of a display for inputting weighting information (a second example).

FIG. 7 is a diagram showing an example of a display for inputting weighting information (a third example).

FIG. 8 is a diagram showing an example of a display for inputting weighting information (a fourth example).

FIG. 9 is a diagram showing an example of a display for inputting weighting information in Modification H.

FIG. 10 is a diagram showing an example of a cost output display in Modification H.

### DETAILED DESCRIPTION OF EMBODIMENT(S)

### (1) Summary of Determination System 10

A determination system 10 according to an embodiment of the present disclosure is used to determine an air-conditioning system 100. The air-conditioning system 100 that is a target of the determination by the determination system 10 is installed in a building (property), and is mainly constituted by outdoor units, indoor units, and ventilation devices. A building in which the air-conditioning system 100 is installed is a relatively large facility, such as an office building, a school, and a hospital.

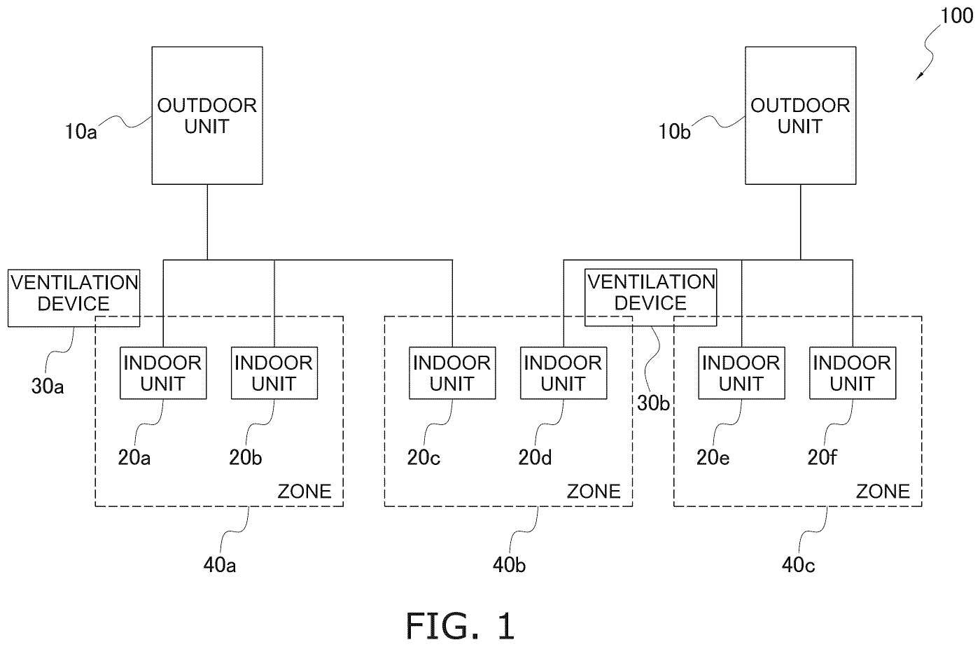

As shown in FIG. 1, the air-conditioning system 100 is constituted by, for example, two outdoor units 10a and 10b, six indoor units 20a to 20f, and two ventilation devices 30a and 30b. Each of the outdoor units 10a and 10b is connected to one or a plurality of ones of the indoor units 20a to 20f via a refrigerant pipe. Each of the indoor units 20a to 20f is connected to one of the two outdoor units 10a and 10b, and is installed in one of zones 40a to 40c of the building in which the air-conditioning system 100 is installed. In FIG. 1, each of the outdoor units 10a and 10b is connected to three of the indoor units 20a to 20f, and two of the indoor units 20a to 20f are installed in each of the zones 40a to 40c. The zones 40a to 40c are an air-conditioning target space air-conditioned by the air-conditioning system 100. The indoor units 20a to 20f maintain the zones 40a to in a comfortable state by removing the sensible heat of the zones 40a to 40c. The ventilation devices 30a and 30b ventilate one or a plurality of ones of the zones 40a to 40c to maintain the zones 40a to 40c in a comfortable state.

The numbers and connection states of outdoor units, indoor units, and ventilation devices included in the air-conditioning system 100 are not limited. For example, the air-conditioning system 100 may not include a ventilation device. For example, the air-conditioning system 100 may have a configuration in which one outdoor unit and one indoor unit are connected by a refrigerant pipe.

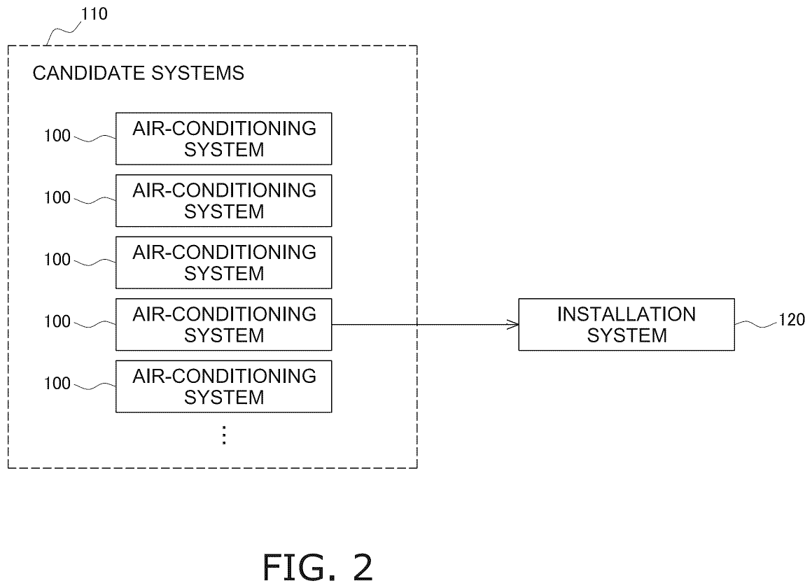

Before installing the air-conditioning system 100 in a building, the configuration of the air-conditioning system 100 to be installed in the building needs to be determined. The builder, the manager, and the like of the building use the determination system 10 to determine, from among candidates (first systems) for an air-conditioning system 100 to be determined, a candidate for an air-conditioning system 100 that satisfies a predetermined criterion (first criterion) as an air-conditioning system 100 appropriate for installment in the building. In the present embodiment, as shown in FIG. 2, the determination system 10 determines one appropriate air-conditioning system 100 as an installation system 120, which is an air-conditioning system 100 appropriate for installation in the building, from among candidate systems 110 constituted by a plurality of candidates for the air-conditioning system 100. The determination system 10 generates candidate systems 110 constituted by a plurality of air-conditioning systems 100 before determining an installation system 120 from among the candidate systems 110.

### (2) Configuration of Determination System 10

The determination system 10 is, for example, a piece of electronic equipment, such as a personal computer (PC) or a mobile terminal. The determination system 10 is constituted by one or a plurality of computers. In a case where the determination system 10 is constituted by a plurality of computers, the plurality of computers may be connected to each other via a network.

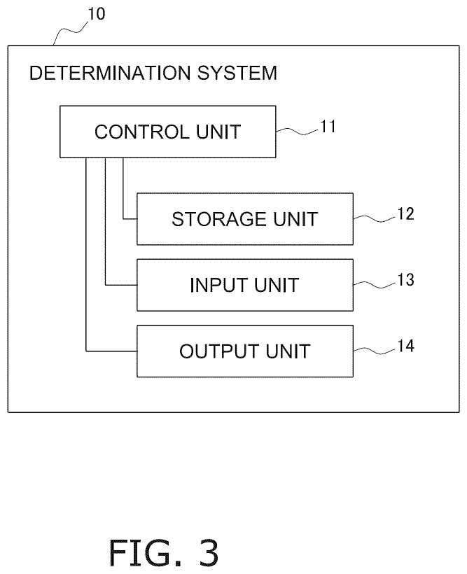

As shown in FIG. 3, the determination system 10 is mainly constituted by a control unit 11, a storage unit 12, an input unit 13, and an output unit 14. These are hardware constituting the determination system 10.

The control unit 11 is a device for executing arithmetic processing for implementing the function of the determination system 10. Specifically, the control unit 11 is an integrated circuit, such as a central processing unit (CPU), an application-specific integrated circuit (ASIC), and a field-programmable gate array (FPGA). The control unit 11 is connected to the storage unit 12, the input unit 13, and the output unit 14 via a wired or wireless communication line. The control unit 11 executes a program stored in the storage unit 12 to perform predetermined arithmetic processing by using data stored in the storage unit 12 and data received from the input unit 13, and transmits data obtained as a result to the output unit 14.

The storage unit 12 is a device for storing programs and data for implementing the function of the determination system 10. Specifically, the storage unit 12 is a main storage device, such as a read-only memory (ROM) and a random-access memory (RAM), and an auxiliary storage device, such as a hard disk drive and a solid-state drive. The storage unit 12 temporarily stores, for example, data used for arithmetic processing by the control unit 11, data obtained as a result of arithmetic processing by the control unit 11, data received from the input unit 13, and data to be transmitted to the output unit 14.

The input unit 13 is a device for a user of the determination system 10 to input predetermined data. Specifically, the input unit 13 is a keyboard of a PC and a touch panel of a mobile terminal. Predetermined data (first information) necessary for implementing the function of the determination system 10 is input into the input unit 13. Data input into the input unit 13 is transmitted to the control unit 11 and the storage unit 12.

The output unit 14 is a device for notifying a user of the determination system 10 of predetermined data. Specifically, the output unit 14 is displays of a PC and a mobile terminal. The output unit 14 outputs predetermined data relating to the function of the determination system 10. The output unit 14 receives predetermined data from the control unit 11 and the storage unit 12 and outputs the received data.

### (3) Operation of Determination System 10

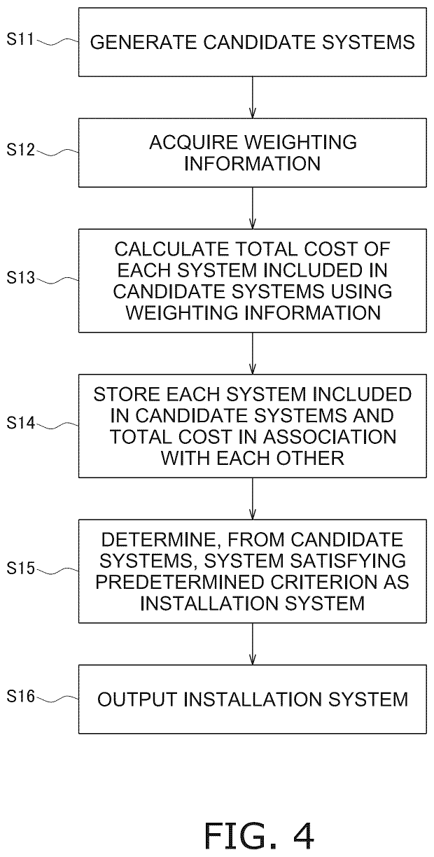

A process in which the determination system 10 determines an installation system 120 from among candidate systems 110 will be described with reference to the flowchart of FIG. 4.

In step S11, candidate systems 110 are generated. Specifically, the control unit 11 generates the candidate systems 110 on the basis of data relating to a plurality of air-conditioning systems 100 (hereinafter referred to as “system-relating data”) stored in advance in the storage unit 12. As the system-relating data, the storage unit 12 stores at least an initial cost and a running cost of each of the air-conditioning systems 100.

The initial cost is a cost required to install the air-conditioning system 100 in a building. Specifically, the initial cost is the cost of equipment (outdoor units, indoor units, and ventilation devices) constituting the air-conditioning system 100, and the cost of the construction for installing the air-conditioning system 100 in a building. The initial cost depends on the structure of a building in which the air-conditioning system 100 is to be installed, the numbers and models of equipment constituting the air-conditioning system 100, the length of a required refrigerant pipe, and the like. The initial cost is a cost incurred only when installing the air-conditioning system 100 in a building.

The running cost is a cost required for using the air-conditioning system 100 installed in a building. Specifically, the running cost is the cost of electric power required to operate equipment constituting the air-conditioning system 100, and the maintenance cost of the air-conditioning system 100. The running cost is a cost that is periodically incurred while the air-conditioning system 100 installed in a building continues to be used. The running cost depends on the numbers and types of equipment constituting the air-conditioning system 100, the length of the refrigerant pipe, the thermal loads of the zones to 40c, and the like. The running cost tends to gradually increase as the use period of the air-conditioning system 100 is longer due to deterioration of equipment constituting the air-conditioning system 100, and the like.

For example, the control unit 11 may set all air-conditioning systems 100 included in the system-relating data as candidate systems 110. Alternatively, the control unit 11 may select some air-conditioning systems 100 from all the air-conditioning systems 100 included in the system-relating data, and set the selected air-conditioning systems 100 as candidate systems 110. For example, a user, a manager, and the like of the determination system 10 may register system-relating data in the determination system 10 in advance and store the system-relating data in the storage unit 12. Alternatively, the determination system 10 may receive system-relating data from an external server or the like via a network and store the system-relating data in the storage unit 12.

In step S12, weighting information (first information) used for calculating the total cost of each of the air-conditioning systems 100 included in the candidate systems 110 is acquired. Specifically, the control unit 11 acquires weighting information input by a user of the determination system 10 using the input unit 13.

The total cost of the air-conditioning system 100 is a cost calculated on the basis of the initial cost and the running cost. The weighting information is information relating to weighting of the initial cost and the running cost in the total cost of the air-conditioning system 100. Specifically, the weighting information is information necessary for acquiring a weighting coefficient of the initial cost (hereinafter referred to as a “first coefficient”) and a weighting coefficient of the running cost (hereinafter referred to as a “second coefficient”). A total cost TC, an initial cost IC, a first coefficient w1, a running cost RC, and a second coefficient w2 satisfy the following Expression (1).

TC=IC·w1+RC·w2 (1)

The first coefficient w1 and the second coefficient w2 are any numerical values equal to or larger than zero. For example, the first coefficient w1 and the second coefficient w2 may be numerical values satisfying a predetermined condition, such as the following Expression (2).

w1+w2=1 (2)

From Expression (1), the total cost TC is affected by the ratio of the first coefficient w1 to the second coefficient w2. Specifically, in a case where the ratio (w1/w2) of the first coefficient w1 to the second coefficient w2 is larger than one, the total cost TC is more affected by the initial cost IC than by the running cost RC. Alternatively, in a case where the ratio (w2/w1) of the second coefficient w2 to the first coefficient w1 is larger than one, the total cost TC is more affected by the running cost RC than by the initial cost IC.

In step S13, the total cost of each of the air-conditioning systems 100 included in the candidate systems 110 is calculated using the weighting information acquired in step S12. Specifically, the control unit 11 calculates the total cost TC of the air-conditioning system 100 on the basis of the initial cost IC, the first coefficient w1, the running cost RC, and the second coefficient w2 of the air-conditioning system 100 by using Expression (1). In order to calculate the total cost, the control unit 11 acquires the initial cost and the running cost stored in the storage unit 12. In order to calculate the total cost, the control unit 11 acquires the first coefficient and the second coefficient on the basis of the weighting information input by the user of the determination system 10 using the input unit 13. A specific example of the weighting information will be described later.

In step S14, each of the air-conditioning systems 100 included in the candidate systems 110 and the total cost calculated in step S13 are stored in association with each other. For example, the control unit 11 stores the total cost of each of the air-conditioning systems 100 in a database stored in the storage unit 12.

In step S15, from the candidate systems 110, an air-conditioning system 100 satisfying a predetermined criterion is determined as an installation system 120. Specifically, the control unit 11 determines, as an installation system 120, an air-conditioning system 100 whose total cost satisfies a predetermined ascertainment criterion (first criterion) from among the air-conditioning systems 100 (candidate systems 110) stored in the storage unit 12 in association with the total costs. For example, the control unit 11 determines, as an installation system 120, an air-conditioning system 100 having the minimum total cost from among all the air-conditioning systems 100 included in the candidate systems 110.

In step S16, the installation system 120 determined in step S15 is output. Specifically, the control unit 11 transmits data relating to the installation system 120 to the output unit 14. The output unit 14 notifies the user of the determination system 10 of the appropriate air-conditioning system 100 determined on the basis of the weighting information input by the user by, for example, displaying data relating to the installation system 120 on the display.

### (4) Specific Example of Weighting Information

A specific example of the weighting information input by a user of the determination system 10 using the input unit 13 will be described.

### (4-1) Weighting Information (First Example)

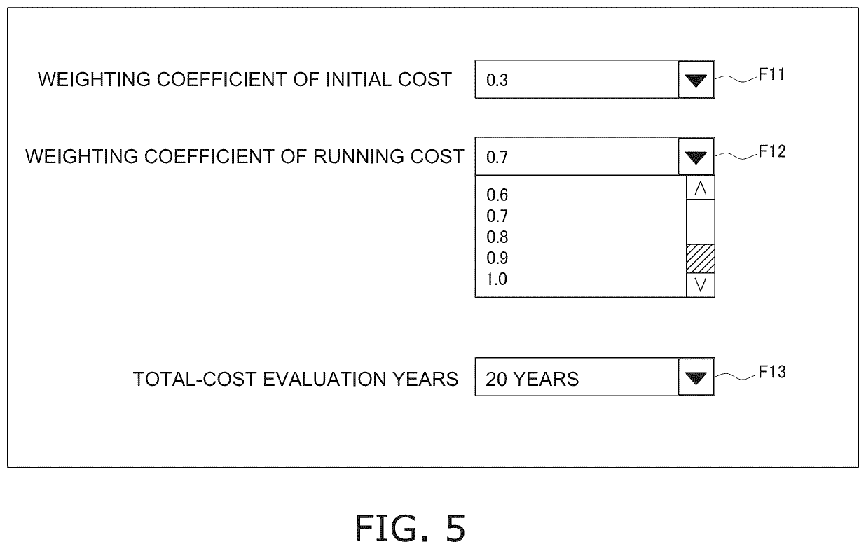

In the present example, a user of the determination system 10 inputs weighting information by inputting a value of the first coefficient and a value of the second coefficient. As shown in FIG. 5, the output unit 14 displays a display for inputting the first coefficient (weighting coefficient of the initial cost) and the second coefficient (weighting coefficient of the running cost). The display of FIG. 5 includes an area Flt for inputting a value of the first coefficient and an area F12 for inputting a value of the second coefficient. The control unit 11 acquires the first coefficient and the second coefficient, which are input weighting information.

For example, a user of the determination system 10 may directly input a value of the first coefficient and a value of the second coefficient into the area Flt and the area F12, respectively. Alternatively, as shown in FIG. 5, a user of the determination system 10 may select a desired first coefficient and a desired second coefficient from among first coefficients and second coefficients included in drop-down lists displayed in the area Flt and the area F12, respectively. Selectable first coefficients and second coefficients are, for example, 0.0, 0.1, 0.2, . . . , 0.9, and 1.0. For example, the control unit 11 may ascertain whether or not an input first coefficient and an input second coefficient satisfy a predetermined condition, such as Expression (2). In a case where the predetermined condition is not satisfied, the control unit 11 may display a warning to that effect on the output unit 14. For example, the control unit 11 may change an input first coefficient and an input second coefficient so as to satisfy the predetermined condition, such as Expression (2).

In the present example, as shown in FIG. 5, a display displayed by the output unit 14 may further include an area F13 for inputting total-cost evaluation years. The total-cost evaluation years are a period as the evaluation target of the running cost of the air-conditioning system 100. For example, in a case where the total-cost evaluation years are 20 years, the control unit 11 calculates the total cost using the running cost required in the period from the present time to 20 years later. The longer the total-cost evaluation years, the higher the running cost and the total cost of the air-conditioning system 100. For example, a user of the determination system 10 may directly input a value of the total-cost evaluation years into the area F13. Alternatively, as shown in FIG. 5, desired total-cost evaluation years may be selected from a list of total-cost evaluation years included in a drop-down list displayed in the area F13. The selectable total-cost evaluation years are, for example, zero years, one year, two years, . . . , 19 years, and 20 years.

### (4-2) Weighting Information (Second Example)

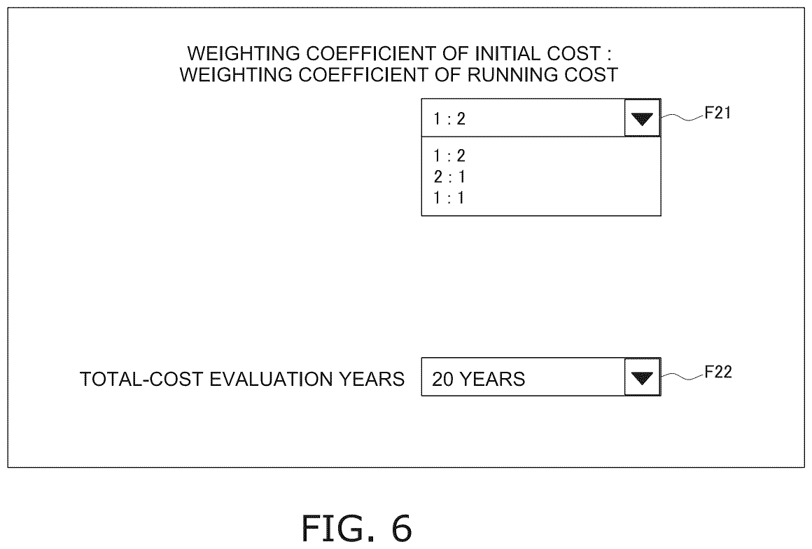

In the present example, a user of the determination system 10 inputs the weighting information by selecting a desired candidate from among candidates for combinations of the first coefficient and the second coefficient (second information). As shown in FIG. 6, the output unit 14 displays a display for inputting a combination of the first coefficient and the second coefficient. The display of FIG. 6 includes an area F21 for inputting a combination of the first coefficient and the second coefficient.

As shown in FIG. 6, for example, a user of the determination system 10 may select a desired candidate from among candidates for combinations of the first coefficient and the second coefficient included in a drop-down list displayed in the area F21. The candidates for combinations of the first coefficient and the second coefficient are set in advance and stored in the storage unit 12. A combination of the first coefficient and the second coefficient is represented by, for example, a ratio (coefficient ratio) of the first coefficient to the second coefficient. Selectable coefficient ratios are, for example, 1:2, 2:1, and 1:1, as shown in FIG. 6. In a case where the coefficient ratio is 1:2, the second coefficient is twice as large as the first coefficient, and the total cost is more affected by the running cost than by the initial cost. In a case where the coefficient ratio is 2:1, the first coefficient is twice as large as the second coefficient, and the total cost is more affected by the initial cost than by the running cost. In a case where the coefficient ratio is 1:1, the first coefficient is equal to the second coefficient, and the total cost is equally affected by the running cost and by the initial cost. The control unit 11 acquires the first coefficient and the second coefficient on the basis of a selected coefficient ratio, which is input weighting information. For example, in a case where a selected coefficient ratio is 1:2, the control unit 11 sets the first coefficient to 0.33 and the second coefficient to 0.67 so as to satisfy Expression (2).

In the present example, as shown in FIG. 6, a display displayed by the output unit 14 may further include an area F22 for inputting the total-cost evaluation years.

### (4-3) Weighting Information (Third Example)

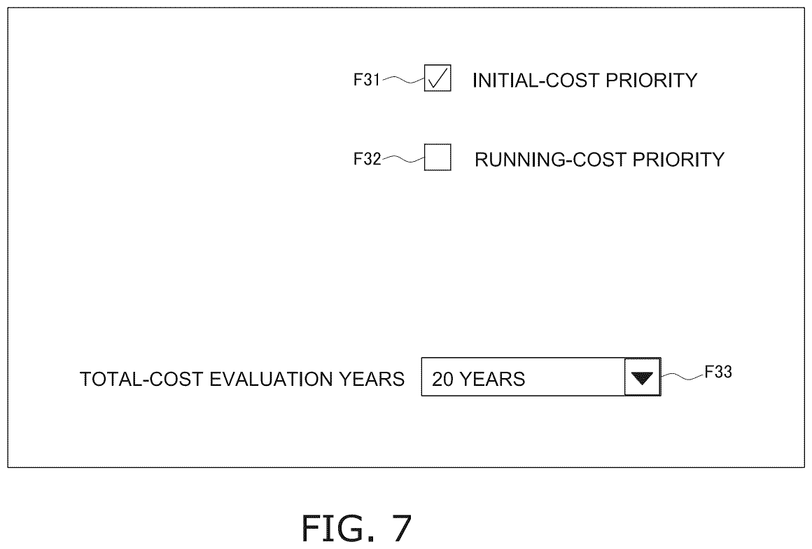

In the present example, a user of the determination system 10 inputs the weighting information by inputting information relating to which of the initial cost and the running cost is to be emphasized. As shown in FIG. 7, the output unit 14 displays a display for inputting information relating to which of the initial cost and the running cost is to be emphasized. The display of FIG. 7 includes an “initial-cost priority” check box F31 indicating that the initial cost is emphasized and a “running-cost priority” check box F32 indicating that the running cost is emphasized.

A user of the determination system 10 selects one of the check boxes F31 and F32. The storage unit 12 stores in advance a combination of the first coefficient and the second coefficient that is set on the basis of which of the initial cost and the running cost is to be emphasized. For example, a combination of the first coefficient and the second coefficient such that the first coefficient is higher than the second coefficient in a case where the “initial-cost priority” check box F31 is selected is stored in the storage unit 12. Further, a combination of the first coefficient and the second coefficient such that the second coefficient is higher than the first coefficient in a case where the “running-cost priority” check box F32 is selected is stored in the storage unit 12. The control unit 11 acquires the first coefficient and the second coefficient on the basis of the selected check box F31 or F32, which is input weighting information.

In the present example, as shown in FIG. 7, a display displayed by the output unit 14 may further include an area F33 for inputting the total-cost evaluation years.

### (4-4) Weighting Information (Fourth Example)

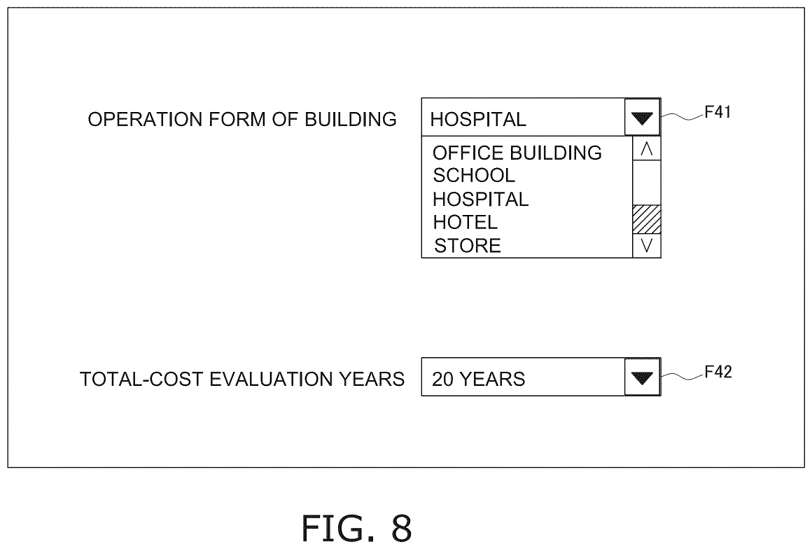

In the present example, a user of the determination system 10 inputs weighting information by inputting information relating to the operation form of a building in which the air-conditioning system 100 is to be installed. As shown in FIG. 8, the output unit 14 displays a display for inputting information relating to the operation form of the building. The display of FIG. 8 includes an area F41 for inputting the type of a building in which the air-conditioning system 100 is to be installed.

A user of the determination system 10 inputs information relating to the type of the building into the area F41. For example, as shown in FIG. 8, a user of the determination system 10 may select a type suitable for a building in which the air-conditioning system 100 is to be installed from among types of buildings included in a drop-down list displayed in the area F41. The selectable types of buildings are, for example, “office building”, “school”, “hospital”, “hotel”, “store”, and the like. The storage unit 12 stores in advance a combination of the first coefficient and the second coefficient that is set for each type of building. For example, the storage unit 12 stores a database in which types of buildings are associated with combinations of the first coefficient and the second coefficient. The control unit 11 acquires the first coefficient and the second coefficient on the basis of a selected building type (operation form), which is input weighting information.

In the present example, as shown in FIG. 8, a display displayed by the output unit 14 may further include an area F42 for inputting the total-cost evaluation years.

### (5) Features

In recent years, customers' requests at a time of determining an air-conditioning system 100 to be installed in a building have been diversified. Therefore, for example, even if an air-conditioning system 100 whose value obtained by simply summing the initial cost and the running cost is low is determined, there is a risk that the customer's request is not satisfied. Specifically, in a case of a customer who plans to install an air-conditioning system 100 in a building and sell the building immediately, it is preferable to more emphasize the initial cost than emphasizing the running cost to determine the air-conditioning system 100 in order to satisfy the customer's request. Alternatively, in a case of a customer who plans to use an air-conditioning system 100 for a period longer than the service life recommended by the manufacturer of the air-conditioning system 100, it is preferable to more emphasize the running cost than emphasizing the initial cost to determine the air-conditioning system 100 in order to satisfy the customer's request.

In order to determine an appropriate air-conditioning system 100 to be installed in a building, the determination system 10 of the present embodiment calculates the total cost of the air-conditioning system 100 on the basis of which of the initial cost and the running cost of the air-conditioning system 100 is emphasized by a customer who is a user of the determination system 10. The total cost of the air-conditioning system 100 calculated by the determination system 10 is a cost optimized on the basis of the customer's request. Therefore, the determination system 10 can determine an appropriate air-conditioning system 100 that reflects the customer's request.

Further, the determination system 10 determines, as an installation system 120, an air-conditioning system 100 whose total cost satisfies a predetermined ascertainment criterion from among candidate systems 110 on the basis of weighting information input by the customer using the input unit 13. The weighting information is selected by the customer, and is information relating to which of the initial cost and the running cost the customer wants to emphasize. Thus, the determination system 10 can determine an appropriate air-conditioning system 100 that reflects the customer's request by proposing an air-conditioning system 100 whose total cost optimized on the basis of the customer's request is lower.

### (6) Modifications

### (6-1) Modification A

The determination system 10 of the embodiment determines one air-conditioning system 100 as an installation system 120 from among candidate systems 110. However, the determination system 10 may determine a plurality of air-conditioning systems 100 as installation systems 120 from among candidate systems 110.

In this case, the control unit 11 may determine all air-conditioning systems 100 whose total costs satisfy a predetermined assessment criterion (second criterion) as installation systems 120 from among candidate systems 110. The air-conditioning systems 100 satisfying the predetermined assessment criterion are, for example, systems having the first to fifth lowest total costs or systems having total costs equal to or lower than a predetermined value. The output unit 14 notifies a user of the determination system 10 of appropriate air-conditioning systems 100 determined on the basis of weighting information input by the user by displaying data relating to all the installation systems 120 determined by the control unit 11 on the display. The user of the determination system 10 can select an air-conditioning system 100 to be actually installed in a building from among the plurality of installation systems 120 displayed on the output unit 14.

### (6-2) Modification B

The determination system 10 of the embodiment can also be utilized to determine a system except the air-conditioning system 100.

Further, the determination system 10 of the embodiment can also be utilized to determine equipment. For example, the determination system 10 can also be utilized to determine equipment, such as an outdoor unit and an indoor unit.

### (6-3) Modification C

After acquiring weighting information input into the input unit 13, for example, the control unit 11 may further acquire a first coefficient and a second coefficient input into the input unit 13. In this case, after inputting weighting information using the input unit 13 to set weighting of the initial cost and the running cost, a user of the determination system 10 can change the weighting of the initial cost and the running cost. Thus, the user of the determination system 10 can later change the weighting of the initial cost and the running cost to more appropriate weighting according to the operation state of a building in which the air-conditioning system 100 is to be installed.

### (6-4) Modification D

For example, the control unit 11 may acquire a second coefficient based on the use period of a building in which an air-conditioning system 100 included in candidate systems 110 is to be used, on the basis of weighting information input into the input unit 13. Specifically, the control unit 11 may automatically set a second coefficient according to a desired use period of the building desired by a user of the determination system 10. As the desired use period of the building, for example, the total-cost evaluation years input into the displays shown in FIGS. 5 to 8 may be used. It is preferable that the longer the desired use period of the building in which an air-conditioning system 100 is to be installed is, the running cost is the more emphasized than emphasizing the initial cost. Therefore, it is preferable that the control unit 11 sets a first coefficient w1 and a second coefficient w2 such that the ratio (w1/w2) of the first coefficient to the second coefficient is smaller as the desired use period of the building set by a user of the determination system 10 is longer. Thus, the user of the determination system 10 can appropriately set weighting of the initial cost and the running cost according to the desired use period of an air-conditioning system 100.

### (6-5) Modification E

The determination system 10 determines an appropriate air-conditioning system 100 as an installation system 120 from among candidate systems 110 constituted by a plurality of candidates for the air-conditioning system 100. The control unit 11 generates the candidate systems 110 on the basis of data relating to a plurality of air-conditioning systems 100 stored in advance in the storage unit 12 (system-relating data).

However, the control unit 11 may generate candidate systems 110 on the basis of data relating to air-conditioning systems 100 (third systems) input by a user of the determination system 10 using the input unit 13. In this case, data relating to the air-conditioning systems 100 included in the candidate systems 110 is further input into the input unit 13 by the user of the determination system 10. Thus, the user of the determination system 10 can set in advance candidates for air-conditioning systems 100 as determination targets.

### (6-6) Modification F

The control unit 11 may generate candidate systems 110 on the basis of information (third information) relating to the installation state of an air-conditioning system 100 input by a user of the determination system 10 using the input unit 13. In this case, the user of the determination system 10 further inputs information relating to the installation state into the input unit 13. The information relating to the installation state is, for example, information relating to the dimensions of a building in which the air-conditioning system 100 is to be installed, and the dimensions of a space in which indoor units of the air-conditioning system 100 are installed. An appropriate air-conditioning system 100 to be installed in a building preferably satisfies minimum specifications determined on the basis of the information relating to the installation state. Therefore, the determination system 10 generates candidate systems 110 on the basis of the information relating to the installation state, and thus the user of the determination system 10 can appropriately determine an air-conditioning system 100 suitable for the installation state of the air-conditioning system 100.

### (6-7) Modification G

For example, the control unit 11 may ascertain whether or not the initial cost and the running cost satisfy a predetermined assessment criterion (third criterion), and may not determine, as an installation system 120, an air-conditioning system 100 that is included in candidate systems 110 and does not satisfy the predetermined assessment criterion. The predetermined assessment criterion is, for example, a criterion relating to whether or not each of the initial cost and the running cost is within a predetermined range. For example, a user of the determination system 10 may input information relating to the predetermined assessment criterion using the input unit 13. For example, a user of the determination system 10 may input ranges of the initial cost and the running cost desired by the user.

In the present modification, the control unit 11 does not determine, as an installation system 120, an air-conditioning system 100 whose initial cost and running cost exceed predetermined values before or after calculation of the total cost. Thus, the determination system 10 can exclude an air-conditioning system 100 whose initial cost and running cost are not within the ranges desired by the user from air-conditioning systems 100 as targets of the determination.

In the present modification, before calculation of the total cost, the control unit 11 may generate candidate systems 110 such that an air-conditioning system 100 whose initial cost and running cost do not satisfy the predetermined assessment criterion is not included in the candidate systems 110.

### (6-8) Modification H

In the present embodiment, as shown in FIG. 7, a user of the determination system 10 can input weighting information by inputting information relating to which of the initial cost and the running cost is to be emphasized.

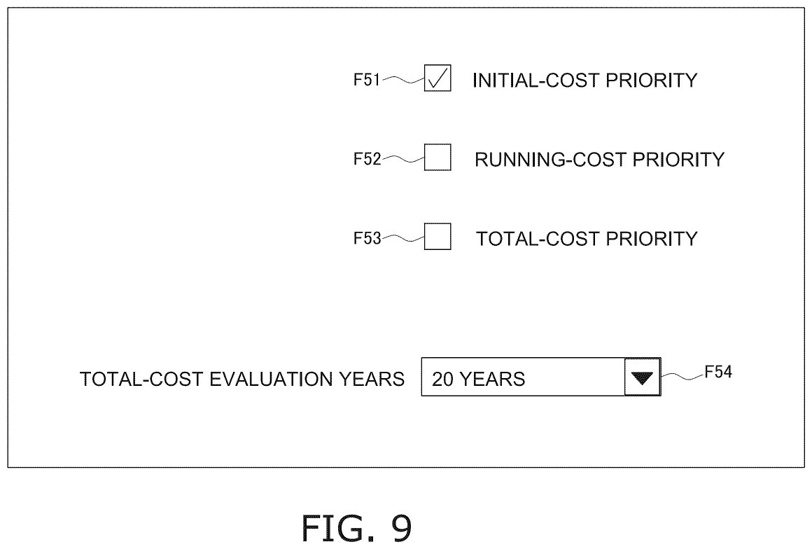

However, as shown in FIG. 9, a user of the determination system 10 may input weighting information by inputting information relating to which of the initial cost, the running cost, and the total cost is to be emphasized.

In the present modification, as shown in FIG. 9, the output unit 14 displays a display for inputting information relating to which of the initial cost, the running cost, and the total cost is to be emphasized. The display of FIG. 9 includes an “initial-cost priority” check box F51 indicating that the initial cost is emphasized, a “running-cost priority” check box F52 indicating that the running cost is emphasized, and a “total-cost priority” check box F53 indicating that the total cost is emphasized.

A user of the determination system 10 selects one of the check boxes F51, F52, and F53. The storage unit 12 stores in advance a combination of the first coefficient and the second coefficient that is set on the basis of which of the initial cost, the running cost, and the total cost is emphasized. For example, a combination of the first coefficient and the second coefficient is stored in the storage unit 12 so that the first coefficient is higher than the second coefficient in a case where the “initial-cost priority” check box F51 is selected. Further, a combination of the first coefficient and the second coefficient is stored in the storage unit 12 so that the second coefficient is higher than the first coefficient in a case where the “running-cost priority” check box F52 is selected. Further, a combination of the first coefficient and the second coefficient is stored in the storage unit 12 so that the first coefficient is equal to the second coefficient in a case where the “total-cost priority” check box F53 is selected. The control unit 11 acquires the first coefficient and the second coefficient on the basis of the selected check box F51, F52, or F53, which is input weighting information.

In the present modification, as shown in FIG. 9, a display displayed by the output unit 14 may further include an area F54 for inputting the total-cost evaluation years.

### (6-9) Modification I

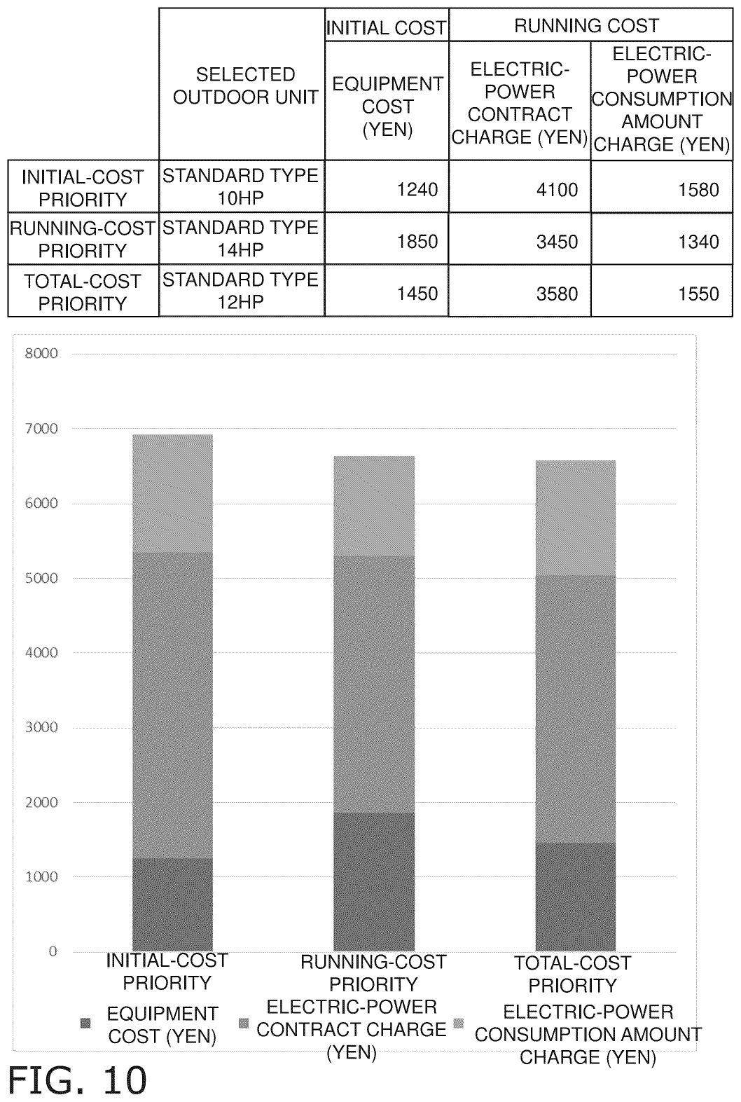

In Modification H, the control unit 11 may calculate the initial cost and the running cost of each of air-conditioning systems 100 included in candidate systems 110, and the output unit 14 may display the calculation result. FIG. 10 shows an example of a cost output display that is a display displaying the initial costs and running costs of air-conditioning systems 100 (installation systems 120) determined in cases where each of the check boxes F51, F52, and F53 of FIG. 9 is selected.

FIG. 10 shows the initial costs and the running costs in a table and a graph. In FIG. 10, the initial cost is constituted by an “equipment cost” that is the cost of the equipment of the air-conditioning system 100, and the running cost is constituted by an “electric-power contract charge” and an “electric-power consumption amount charge” that are the cost of electric power necessary for the operation of the equipment constituting the air-conditioning system 100. In the table of FIG. 10, information relating to the models of the outdoor units of the installation systems 120 determined by the determination system 10 is described in the column of “selected outdoor unit”.

In the present modification, a user of the determination system 10 can efficiently select an appropriate air-conditioning system 100 based on the initial cost, the running cost, and the total cost by referring to the cost output display shown in FIG. 10.

### (6-10) Modification J

The control unit 11 may correct the running cost and the like of an air-conditioning system 100 on the basis of a parameter, such as the margin rate of the capacity of the equipment of the air-conditioning system 100. In this case, a user of the determination system 10 may input a parameter that affects the total cost of the air-conditioning system 100, such as the margin rate, using the input unit 13.

### (6-11) Modification K

For example, the control unit 11 may select some air-conditioning systems 100 from all air-conditioning systems 100 included in system-relating data, and set the selected air-conditioning systems 100 as candidate systems 110. In this case, the control unit 11 may select air-conditioning systems 100 on the basis of a predetermined condition except the initial cost and the running cost to generate candidate systems 110.

For example, the control unit 11 may generate candidate systems 110 such that an air-conditioning system 100 whose pieces of equipment (outdoor units, indoor units, and ventilation devices) have capacity, design, a model number, and a price that satisfy predetermined conditions, or whose refrigerant pipe installed in the building has a length that satisfies a predetermined condition is included in the candidate systems 110. In this case, a user of the determination system 10 may input information relating to the predetermined conditions using the input unit 13.

Although the embodiment of the present disclosure has been described above, it will be understood that various changes in the forms and details can be made without departing from the spirit and scope of the present disclosure as set forth in the claims.

1. A determination system for determining an appropriate air-conditioning system, the determination system comprising:
a control unit;
a storage unit; and
an input unit,
the control unit being configured to
generate a first system that is a candidate for an air-conditioning system to be determined,
acquire first information relating to weighting of an initial cost and a running cost of the first system in a total cost of the first system including the initial cost and the running cost,
acquire, based on the first information, a degree of how the total cost is affected by each of the initial cost and the running cost, and
calculate the total cost by adding the initial cost and the running cost based on the degree,
the storage unit stores the first system and the total cost calculated by the control unit in association with each other,
the first information acquired by the control unit is input into the input unit, and
the control unit is configured to determine, from the first system stored in the storage unit, the first system the total cost of which satisfies a first criterion as the appropriate air-conditioning system.

2. The determination system according to claim 1, further comprising:
an output unit configured to output the appropriate air-conditioning system determined by the control unit.

3. The determination system according to claim 1, wherein
the control unit is configured to
acquire a first value that is a value of the weighting of the initial cost and a second value that is a value of the weighting of the running cost on a basis of the first information input into the input unit, and
calculate the total cost based on the initial cost, the running cost, the first value, and the second value.

4. The determination system according to claim 3, wherein
the first information is the first value and the second value.

5. The determination system according to claim 3, wherein
the storage unit further stores second information including candidates for the first value and the second value, and
the first information is the first value and the second value included in the second information.

6. The determination system according to claim 3, wherein
the storage unit further stores the first value and the second value that are set based on which of the initial cost and the running cost is to be emphasized, and
the first information is information relating to which of the initial cost and the running cost is to be emphasized.

7. The determination system according to claim 3, wherein
the storage unit further stores the first value and the second value that are set based on an operation form of a property in which the first system is to be used, and
the first information is information relating to the operation form.

8. The determination system according to claim 3, wherein
the control unit is configured to further acquire the first value and the second value input into the input unit after the control unit acquires the first information input into the input unit.

9. The determination system according to claim 3, wherein
the control unit is configured to acquire, based on the first information, the second value based on a use period of a property in which the first system is to be used.

10. The determination system according to claim 1, wherein
the control unit is configured to determine the first system the total cost of which is minimum as the appropriate air-conditioning system.

11. The determination system according to claim 1, wherein
the control unit is configured to determine the first system the total cost of which satisfies a second criterion as the appropriate air-conditioning system.

12. The determination system according to claim 1, wherein
a third system that is a candidate for the air-conditioning system to be determined is further input into the input unit, and
the control unit is configured to generate the first system based on the third system.

13. The determination system according to claim 1, wherein
third information relating to an installation state of the air-conditioning system to be determined is further input into the input unit, and
the control unit is configured to generate the first system based on the third information.

14. The determination system according to claim 1, wherein
the control unit is configured to
ascertain whether or not the initial cost and the running cost satisfy a third criterion, and
not determine the first system that does not satisfy the third criterion as the appropriate air-conditioning system.

15. The determination system according to claim 2, wherein
the control unit is configured to
acquire a first value that is a value of the weighting of the initial cost and a second value that is a value of the weighting of the running cost on a basis of the first information input into the input unit, and
calculate the total cost based on the initial cost, the running cost, the first value, and the second value.

16. The determination system according to claim 2, wherein
the control unit is configured to determine the first system the total cost of which is minimum as the appropriate air-conditioning system.

17. The determination system according to claim 2, wherein
the control unit is configured to determine the first system the total cost of which satisfies a second criterion as the appropriate air-conditioning system.

18. The determination system according to claim 2, wherein
a third system that is a candidate for the air-conditioning system to be determined is further input into the input unit, and
the control unit is configured to generate the first system based on the third system.

19. The determination system according to claim 2, wherein
third information relating to an installation state of the air-conditioning system to be determined is further input into the input unit, and
the control unit is configured to generate the first system based on the third information.

20. The determination system according to claim 2, wherein
the control unit is configured to
ascertain whether or not the initial cost and the running cost satisfy a third criterion, and
not determine the first system that does not satisfy the third criterion as the appropriate air-conditioning system.
